(19) United States
(12) Patent Application Publication
(10) Pub. No.: US 2017/0066081 A1
(43) Pub. Date: Mar. 9, 2017

(54) POWDER SPRAYING NOZZLE, RECEPTACLE UNIT AND MACHINING HEAD FOR A LASER-BASED MATERIAL MACHINING DEVICE

(71) Applicant: OERLIKON METCO AG, WOHLEN, Wohlen (CH)

(72) Inventors: Thomas PETERS, Lenzburg (CH); Tobias LEUPPI, Dottikon (CH); Andreas GISLER, Riet bei Neftenbach (CH)

(73) Assignee: OERLIKON METCO AG, WOHLEN, Wohlen (CH)

(21) Appl. No.: 15/123,135

(22) PCT Filed: Mar. 2, 2015
(86) PCT No.: PCT/EP2015/054237

§ 371 Date: Sep. 1, 2016

(30) Foreign Application Priority Data
Mar. 4, 2014 (EP) 14157564.7

(51) Int. Cl. B23K 26/144; B23K 26/342

(52) U.S. Cl. CPC B23K 26/144; B23K 26/342

(57) ABSTRACT

The invention relates to a powder flow nozzle, to a receiver unit and to a processing head for an apparatus for a processing of material with a laser.

In order to enable a simple exchange of the powder flow nozzle it is suggested in accordance with the invention that an outer contour of a mounting spigot (11) of the powder flow nozzle (10) monotonously tapers in a plug-in region (16) in the plug-in direction (14).

The invention relates to a powder flow nozzle for an apparatus for a processing of material with a laser in accordance with the preamble of the claim 1, to a receiver unit for a powder flow nozzle of an apparatus for a processing of material with a laser in accordance with the preamble of the claim 5 and to a processing head for an apparatus for a processing of material with a laser having the features of the claim 10.

The processing of material with a laser can in particular be carried out as laser beam deposition welding with powder. This method is, for example, used for the maintenance, wear protection and corrosion protection in many fields, such as for example, tool making, mold making, construction of power units and machine engineering. In this connection, a melt spot is generated at a component with a laser beam and the powder of the additional material is supplied to the melt spot via a powder flow nozzle. The supplied powder then likewise melts and connects with the molten basic material of the component. Through a movement of the unit composed of the laser and the powder flow nozzle over the component a so-called weld bead arises. The individual weld beads can be placed so close to one another that a closed layer arises at the component which can be machined for an increase of the surface quality.

The powder flow nozzles used in this connection are exposed to very high temperatures and are subjected to wear by means of the powder conveyed there through. Moreover, completely or partly molten powder which is deflected from the component can adhere to the powder flow nozzle. These adhesions must be removed regularly in order to ensure an error-free operation without a blockage of the powder supply. For this reason, powder flow nozzles for apparatuses for the processing of material with a laser, in particular for the laser beam deposition welding with powder have to be configured exchangeable.

In the DE 10 2005 058 172 B4 an apparatus for a processing of material with a laser in the form of laser beam deposition welding is described. The apparatus has a powder flow nozzle with a through passage for a beam. The through passage for a beam has a beam inlet opening and a beam outlet opening disposed opposite in an axial direction. The powder flow nozzle further has a mounting spigot at which the beam inlet opening can be configured and by means of which a fixation or fastening of the powder flow nozzle is enabled. For the fixation of the powder flow nozzle, a cylindrical plug-in region having a circumferential groove is plugged into a hollow cylindrical receiver sleeve not described in detail. The receiver sleeve has a plurality of bores distributed about its circumference into which grub screws can be screwed. The positions of the bores are selected in such a way that for a plugged-in powder flow nozzle, the grub screws immerse into the groove and thus fix the powder flow nozzle with respect to the receiver sleeve. On a removal of the powder flow nozzle the grub screws have to be released and can fall out. On installation of the powder sleeve this has to be introduced into the correct axial and/or plug-in position and held there. Only then can the grub screws be screwed in.

The pairing of the mounting spigot and receiver sleeve over the complete immersion depth acts as a centering of the powder flow nozzle having regard to the apparatus described in the DE 10 2005 058 172 B4. As a tight fit is in this way required over the complete immersion depth the centering is very sensitive with respect to contamination. Already a low level of contamination can lead to a mis-clamping of the mounting spigot in the receiver sleeve.

In contrast to this, it is the object of the invention to suggest a powder flow nozzle, a receiver unit for a powder flow nozzle and a processing head for an apparatus for a processing of material with a laser which enables a simple exchange of the powder flow nozzle. In accordance with the invention this object is satisfied by a powder flow nozzle having the features of the claim 1, by a receiver unit having the features of the claim 5 and by a processing head having the features of the claim 10.

The powder flow nozzle in accordance with the invention for an apparatus for a processing of material with a laser comprises a through passage for a beam which has a beam inlet opening and a beam outlet opening disposed opposite in an axial direction. In operation of the apparatus the laser beam enters the through passage for a beam via the beam inlet opening and exits it again via the beam inlet opening before it is incident on the workpiece to be processed. The powder flow nozzle further has a mounting spigot at which the beam inlet opening is formed. A fixation or fastening of the powder flow nozzle is enabled by means of the mounting spigot, in particular in a receiver sleeve of a receiver unit of the apparatus for the processing of material with a laser.

In accordance with the invention the mounting spigot is configured in such a way that an outer contour of the mounting spigot monotonously tapers in a direction of the beam inlet opening in a plug-in region arranged in the direction of the beam inlet opening. In this way the powder flow nozzle can be plugged in so far on an insertion into the receiver sleeve up until the outer contour of the mounting spigot contacts at a corresponding inner contour of the receiver sleeve and the powder flow nozzle can in this way not be pushed in any further. In this position, the powder flow nozzle is unambiguously defined axially and radially with respect to the receiver sleeve and in this way with respect to the receiver unit and can be fixed using suitable fixation means. In this way the powder flow nozzle can be fixed particularly simply in the receiver unit at the correct position. Moreover, a very low susceptibility with respect to contamination results by means of this taper.

“Monotonously tapers” should in this connection be understood such that the outer contour tapers without the cross-section again becoming larger in the direction of the beam inlet opening. The cross-section can in this respect also remain constant in sections. A “plug-in region” should in this connection be understood as the region in which the receiver sleeve is immersed.

The powder flow nozzle is in particular used on laser beam deposition welding with powder. The use for other material processes with a laser, such as, for example, laser cutting or laser welding is also likewise possible. In these cases no powder is guided through the powder flow nozzle.

In an embodiment of the invention the plug-in region of the mounting spigot has circular cross-sections which change in the axial direction due to the described tapering of the plug-in region. The mentioned cross-sections result as sections through the plug-in region transverse to the axial direction, the plug-in region is in this respect rotationally symmetric with respect to the axial direction. The plug-in region is in this way at least sectionally conically configured. In this way, the plug-in region and thus the mounting spigot can be produced particularly simply by rotary machining. This is in particular true when the overall outer contour of the powder flow nozzle is of rotationally symmetric design.

The powder flow nozzle does not have to be installed at a certain angular position with respect to the receiver sleeve. If an insertion at a certain angular position is required for certain regions, then the powder flow nozzle and the receiver sleeve can have a groove and a corresponding tongue for positioning.

In an embodiment of the invention an outer contour of the plug-in region of the mounting spigot has an angle of taper of between 2 and 8°. In this way in particular a self-retention is achieved when the powder flow nozzle is plugged into a corresponding receiver sleeve. This is in particular advantageous on a plugging in and a fixing of the powder flow nozzle. In this way it can be brought into the correct position and remains in this also when this is not held. In this way one can use both hands for the actual locking or fastening. In this way a receiver having a conical design of the plug-in region also has advantages with respect to a powder flow nozzle which does not have to rotate and the receiver does not have to accommodate tool forces in contrast to receivers for rotating tools, such as for example, millers or bolts.

The angle of taper in this connection is formed between a tapering section of the plug-in region and the axial direction.

In an embodiment of the invention the plug-in region of the mounting spigot is limited in the direction of the beam outlet opening by a widening or via which a force which can be introduced in the direction of the beam outlet opening. In this way a force can be exerted onto the powder flow nozzle in a simple manner on a removal of the powder flow nozzle. The widening is in particular configured as a surrounding collar which has no connections, for example, for the powder or for a cooling liquid. The widening in particular reduces again in the direction of the beam outlet opening such that the powder flow nozzle does not have too much material and in this way weight.

The mentioned object is also satisfied by a receiver unit for a powder flow nozzle of an apparatus for a processing of material with a laser having a receiver sleeve. The receiver sleeve has a receiver space having a plug-in opening and a transition opening disposed opposite in an axial direction. The receiver space is provided for the purpose of receiving a plug-in region of a mounting spigot of the powder flow nozzle in a plug-in direction. Thereby, an inner contour of the receiver sleeve tapers, at least in a section, in the direction of the transition opening. In this way the powder flow nozzle can, as already described above, be fixed in the receiver unit in a particularly simple manner. The plug-in direction in this connection extends in parallel to the above-described axial direction and is oriented from the plug-in opening to the transition opening. During the operation of the apparatus the laser beam enters via the transition opening into the receiver sleeve and exits this again via the plug-in opening.

In accordance with the invention a clamping nut is arranged in the region of the plug-in opening of the receiver sleeve which can be displaced with respect to the receiver sleeve in the plug-in direction and against the plug-in direction. A clamping sleeve is arranged within the receiver sleeve. The clamping nut has an inner chamfer and the clamping sleeve has an outer chamfer which are configured and arranged in such a way that, on a displacement of the clamping nut in a clamping direction, the clamping sleeve is compressed transverse to the plug-in direction and in this connection a powder flow nozzle plugged into the clamping sleeve is fixed. The receiver sleeve in particular has an outer thread and the clamping nut has a corresponding inner thread. In this way, a particularly simple and secure fixation of the powder flow nozzle is ensured in the receiver opening. A secure fixation of the powder flow nozzle can be achieved through a simple removal of the only one clamping nut. The clamping direction in particular corresponds to the plug-in direction. The clamping nuts can have bores or planar surfaces at their circumference over which a tool can be placed for the tightening or release of the clamping nut.

In an embodiment of the invention the clamping sleeve is configured as a slotted sleeve. The slots in this connection extend in particular in an axial direction. The clamping sleeve can, for example, have four or more slots. Such a clamping sleeve can be compressed in a comparatively good manner which permits a secure fixation of the powder flow nozzle. Moreover, such a clamping sleeve can be produced simply and cost-effectively.

In an embodiment of the invention the clamping sleeve has an outer thread and the receiver sleeve has an inner thread by means of which the clamping sleeve can be connected to the receiver sleeve. The outer thread of the clamping sleeve is in this connection arranged in particular at its end oriented in the direction of the transition opening of the receiver sleeve. In this way a simple and secure fixation of the clamping sleeve is enabled in the receiver sleeve.

In an embodiment of the invention the outer thread and the inner thread of the receiver sleeve have different directions of rotation. In this way it is securely prevented that, on a release of the clamping nut, the connection between the clamping sleeve and the receiver sleeve is also released at the same time. On a tightening of the clamping nut the connection between the clamping sleeve and the receiver sleeve can likewise not be released, as the clamping sleeve is not only compressed via the named chamfers, but rather that a force is also applied there in the direction of the transition opening. The outer thread is in particular configured as a right hand thread and the inner thread is configured as a left hand thread.

The mentioned object is also satisfied by a processing head for an apparatus for a processing of material with a laser with a powder flow nozzle and a receiver unit having the above-described features.

In an embodiment of the invention the powder flow nozzle has a widening and the receiver unit has a clamping nut having a push-out chamfer. These are configured and arranged in such a way that, on a displacement of the clamping nut with respect to the plug-in sleeve against the plug-in direction, the powder flow nozzle is likewise displaced against the plug-in direction. In this way, a force is exerted against the plug-in direction on the powder flow nozzle on a displacement of the clamping nut against the plug-in direction, this means in particular on a release of or a turning open of the clamping nut via the push-out chamfer and the widening. By means of this force a current self-retention can be overcome and the powder flow nozzle can be pushed out of the receiver sleeve in a simple and controlled manner.

Further advantages, features and particulars of the invention result by means of the subsequent description of embodiments, as well as with reference to the drawing in which all like or functionally like elements are provided with identical reference numerals.

There is shown:

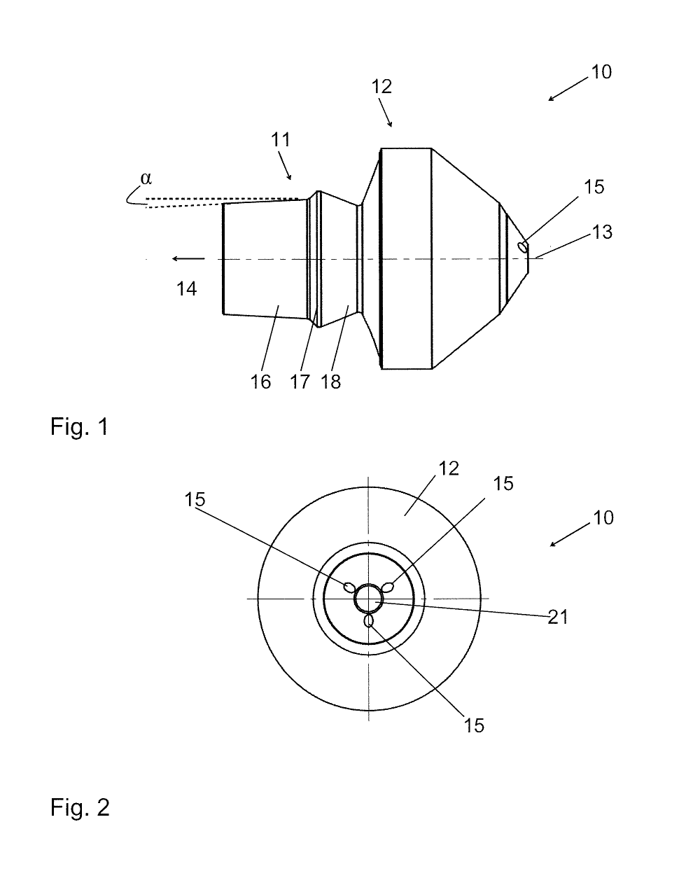

FIG. 1 a side view of a powder flow nozzle for an apparatus for laser beam deposition welding with powder;

FIG. 2 a front view of the powder flow nozzle of FIG. 1; and

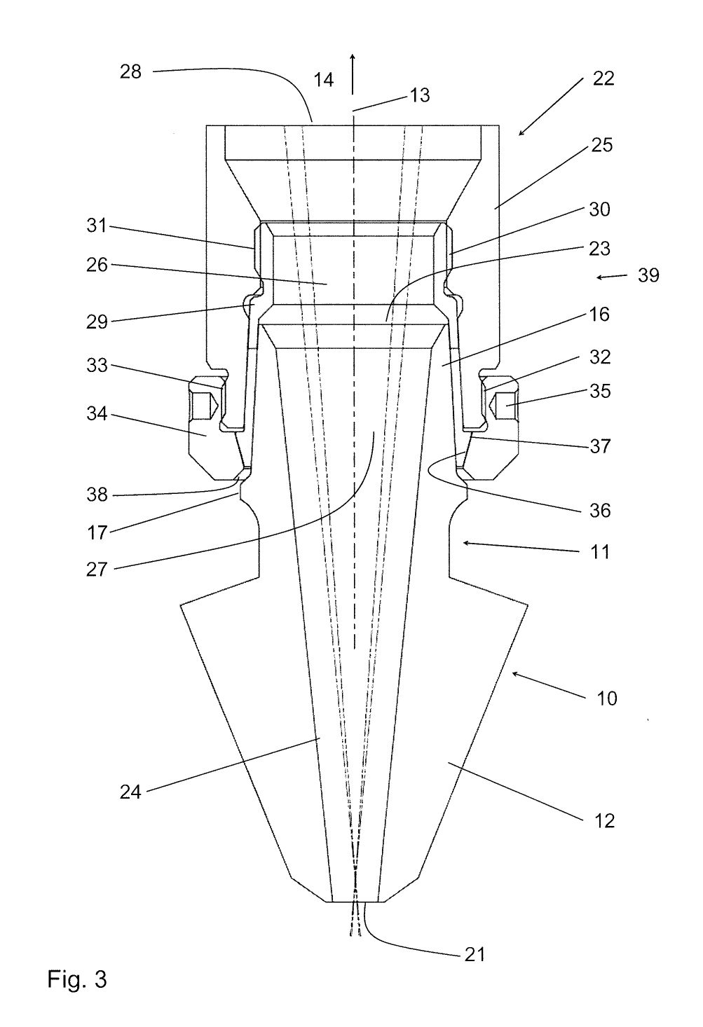

FIG. 3 a section through a processing head for an apparatus for laser beam deposition welding with powder having a powder flow nozzle and a receiver unit.

In accordance with FIG. 1 a powder flow nozzle 10 has a mounting spigot 11 and a head part 12 for a non-further illustrated apparatus for laser beam deposition welding with powder. The outer contour of the powder flow nozzle 10 is formed rotationally symmetric with respect to an axial direction 13. The complete mounting spigot 11 in this way has circular cross-sections transverse to the axial direction 13. The powder flow nozzle 10 can be fixed in a receiver sleeve 25, only illustrated in FIG. 3, via the mounting spigot 11 and in this way the powder flow nozzle 10 is held. For this purpose, the powder flow nozzle 10 can be plugged into the receiver sleeve 25 in a plug-in direction 14 which extends in parallel with respect to the axial direction 13.

The head part 12 is adjacent to the mounting spigot 11 in a direction opposite to the plug-in direction 14. During operation of the apparatus for laser beam deposition welding with powder a laser beam enters via a beam inlet opening 23 (see FIG. 3) at the mounting spigot 11 into a through passage 24 for a beam (see FIG. 3) of the powder flow nozzle 10 and exits the powder flow nozzle 10 again via a beam outlet opening 21 (see FIGS. 2 and 3) at the head part 12 in order to generate a so-called melt spot at a workpiece to be machined. The beam inlet opening 23 and the beam outlet opening 21, as well as the through passage 24 for a beam are not illustrated in the FIG. 1. An additional material which is supplied in powder form via three non-illustrated connections at the head part 12 again exits via a total of three powder outlet openings 15 at the head part 12, with only one powder opening 15 being visible in the FIG. 1. The powder outlet openings 15 are arranged in such a way that the powder is conveyed to the melt spot at the workpiece to be machined.

The mounting spigot 11 has three different regions. It tapers via a plug-in region 16 which includes the beam inlet opening 23, and in this way is arranged in the direction of the beam inlet opening 23. On plugging in into the receiver sleeve 25 the plug-in region 16 of the mounting spigot 11 immerses into the receiver sleeve 25. A widening 17 adjoins at the plug-in region 16 against the plug-in direction 14 and in this way in the direction of the beam outlet opening 21. In the region of the widening 17 a diameter of the mounting spigot 11 strongly increases via a chamfer, wherein also a jump-like increase in diameter would be possible. A transition region 18 is adjacent to the widening 17 with the head part 12 ending at the transition region. The diameter of the mounting spigot 11 continuously decreases in the transition region 18, wherein, as illustrated in FIG. 3, also other extents of diameter are possible. The head part 12 likewise has a plurality of regions with different diameter extents. The assembly of the head part 12 is in this connection of no further interest, such that a detailed description of the head part 12 is omitted.

The outer contour of the plug-in region 16 of the mounting spigot 11 is not of cylindrical design, but tapers monotonously in the plug-in direction 14 and in this way in the direction of the beam inlet opening 23. An angle of taper α which is formed between the outer contour of the plug-in region 16 and the axial direction 13 amounts to 3° having regard to the powder flow nozzle 10 illustrated in FIG. 1. The angle of taper can also amount to between 2° and 8°. It is thus selected in such a way that, on a plugging in of the mounting spigot 11 into a corresponding receiver sleeve, a self-retention arises.

The plug-in region 16 of the mounting spigot 11 can, for example, have a diameter of between 20 and 50 mm and the head region 12 can have a maximum diameter of between 40 and 70 mm. The overall length of the powder flow nozzle 10 can, for example, amount to between 60 and 90 mm.

In the front view of the powder flow nozzle 10 illustrated in FIG. 2 only the head part 12 can be seen. The head part 12, like the overall powder flow nozzle 10, has an outer contour with circular diameters. The beam outlet opening 21 is centrally arranged at the head part 12 from which the laser beam exits from the nozzle head 10 during the operation of the apparatus. The three powder outlet openings 15 are arranged uniformly distributed about the beam outlet opening 21.

In accordance with FIG. 3 a processing head 22 for an apparatus for the laser beam deposition welding with powder has a powder flow nozzle 10 which is generally of like design as the powder flow nozzle 10 in FIG. 1. The beam outlet opening 21 is configured at the head part 12. The beam inlet opening 23 is configured at the plug-in region 16 of the mounting spigot 11. A through passage 24 for a beam extends against the plug-in direction 14 in a continuously tapering manner between the beam inlet opening 23 and the beam outlet opening 21. The beam inlet opening 23 and the beam outlet opening 21 are in this respect arranged disposed opposite in the axial direction 13. The plug-in region 16 of the mounting spigot 11 tapers, as described in FIG. 1, in a monotonous manner in the direction of the beam inlet opening 23.

The processing head 22 further has a plug-in sleeve 25 which is generally configured hollow-cylindrical and in this way forms a receiver space 26 having a plug-in opening 27 into which the powder flow nozzle 10 can be plugged. The plug-in sleeve 25 has a transition opening 28 lying disposed opposite in the axial direction 13 via which the laser beam enters into the receiver sleeve 25 during the operation of the apparatus, the laser beam leaving the receiver sleeve again via the plug-in opening 27. The inner contour of the receiver sleeve 25 tapers in a region in which the plug-in region 16 of the mounting spigot immerses continuously in the direction of the transition opening 28. The tapering of the inner contour of the receiver sleeve 25 in this connection corresponds to the taper of the outer contour of the plug-in region 16 of the mounting spigot 11.

A slotted clamping sleeve 29 is arranged between the receiver sleeve 25 and the plug-in region 16 of the mounting spigot 11. The clamping sleeve 29 generally has a hollow cone-shaped basic shape which widens in the direction of the plug-in opening 27. It has a total of 4 slots which extend in the plug-in direction 14. The clamping sleeve 29 has an outer thread 30 in the direction of the transition opening 28. The receiver sleeve 25 is connected to the clamping sleeve 29 having the receiver sleeve 25 via this outer thread 30 and a corresponding inner thread 31. The two mentioned threads 30, 31 are configured as left-handed threads.

The receiver sleeve 25 further has an outer thread 32 in the region of the plug-in opening 27 which cooperates with an inner thread 33 of a clamping nut 34. The clamping nut 34 can be screwed on and screwed off the receiver sleeve 25 via the outer thread 32 and the inner thread 31 and can in this way be displaced in or against the plug-in direction 14 with respect to the receiver sleeve 25. The two mentioned threads 32, 33 are configured as right-hand threads. In order to be able to introduce a higher torque into the clamping nut 34 a plurality of bores 35 are arranged distributed about its circumference.

The clamping nut 34 further has a circumferential planar inner chamfer 36 displaced with respect to the plug-in direction 14. The inner chamfer 36 is configured in such a way that an internal diameter increases in the plug-in direction 14. The inner chamfer 36 of the clamping nut 34 cooperates with a corresponding outer chamfer 37 of the clamping sleeve 29. On a rotation of the clamping nut 34 onto the receiver sleeve 25, this means on a displacement of the clamping nut 34 in a clamping direction which corresponds to the plug-in direction 14, a force acts inwardly on the clamping sleeve 29 via the inner chamfer 36 and the outer chamfer 37 which presses the clamping sleeve 29 transverse to the plug-in direction 14 and thus fixes the plug-in region 16 of the mounting spigot 11 and in this way fixes the complete powder flow nozzle 10 in the clamping sleeve 25. The receiver sleeve 25, the clamping sleeve 29 and the clamping nut 34 in this way form a receiver unit 39 for a powder flow nozzle 10.

The clamping nut 34 further has a planar push-out chamfer 38 which is arranged at an end lying disposed opposite of the transition opening 28. The push-out chamfer 38 is inwardly inclined in the plug-in direction 14. The push-out chamfer 38 of the clamping nut 34 is configured in such a way that it comes into contact at the widening 17 of the receiver shaft 11 of the powder flow nozzle 10 on a screwing of the clamping nut 34 from the receiver sleeve 25 and the powder flow nozzle 10 is in this way likewise displaced against the plug-in direction 14.

The receiver unit 39 formed by the receiver sleeve 25, the clamping sleeve 29 and the clamping nut 34 and the powder flow nozzle 10 in this way form a processing head 22 for an apparatus for laser beam deposition welding with powder.

The assembly and disassembly of the powder flow nozzle 10 in this connection is carried out as follows.

On assembly of the powder flow nozzle 10 this is plugged into the receiver sleeve 25 so far until the outer contour of the plug-in region 16 of the receiver shaft 11 of the powder flow nozzle 10 contacts the inner contour of the clamping sleeve 29. In this way an axial and radial positioning of the powder flow nozzle 10 is achieved. Due to the described self-retention between the powder flow nozzle 10 and the receiver sleeve 25 and/or the clamping sleeve 29, the powder flow nozzle 10 remains in the set position without it having to be held. Subsequently, the clamping nut 34 is screwed onto the receiver sleeve 25 and in this way, as described, the clamping sleeve 29 is compressed and the powder flow nozzle 10 is fixed. In this way, the assembly of the powder flow nozzle 10 is completed apart from the connection of further supply lines.

Having regard to the disassembly of the powder flow nozzle 10 the clamping nut 34 is screwed off of the receiver sleeve 25 and in this way the powder flow nozzle 10 is simultaneously pushed out of the receiver sleeve 25 as described.

1. A powder flow nozzle for an apparatus for a processing of material with a laser comprising
a through passage (24) for a beam which has a beam inlet opening (23) and a beam outlet opening (21) disposed opposite in an axial direction (13); and
a mounting spigot (11) at which the beam inlet opening (23) is formed and by means of which a fixation of the powder flow nozzle (10) is enabled,
characterized in that
an outer contour of the mounting spigot (11) monotonously tapers in the direction of the beam inlet (23) in a plug-in region (16) arranged in the direction of the beam inlet opening (23).

2. A powder flow nozzle in accordance with claim 1,
characterized in that
the plug-in region (16) of the mounting spigot (11) has circular cross-sections.

3. A powder flow nozzle in accordance with claim 1,
characterized in that
an outer contour of the plug-in region (16) of the mounting spigot (11) has an angle of taper α of between 2° and 8°.

4. A powder flow nozzle in accordance with claim 1,
characterized in that
the plug-in region (16) of the mounting spigot (11) is limited in the direction of the beam outlet opening (21) by a widening (17) via which a force can be introduced in the direction of the beam inlet opening (21).

5. A receiver unit for a powder flow nozzle of an apparatus for a processing of material with a laser having a receiver sleeve (25) which has a receiver space (26) having a plug-in opening (27) and a transition opening (28) lying disposed opposite in an axial direction (13) and is provided for the purpose of receiving a plug-in region (16) of a mounting spigot (11) of the powder flow nozzle (10) in a plug-in direction (14),
wherein an inner contour of the receiver sleeve (25) tapers, at least in a section, in the direction of the transition opening (28)
characterized in that
a clamping nut (34) is arranged in the region of the plug-in opening (27) of the receiver sleeve (25), the clamping nut being able to be displaced with respect to the receiver sleeve (25) in the plug-in direction (14) and against the plug-in direction (14);
a clamping sleeve (29) is arranged within the receiver sleeve (25); and
the clamping nut (34) has an inner chamfer (36) and the clamping sleeve (29) has an external chamfer (37) which are configured and arranged in such a way that, on a displacement of the clamping nut (34) in a clamping direction (14), the clamping sleeve (29) is pressed together transverse to the plug-in direction (14).

6. A receiver unit in accordance with claim 5,
characterized in that
the receiver sleeve (25) has an outer thread (32) and a clamping nut (34) has a corresponding inner thread (33).

7. A receiver unit in accordance with claim 5,
characterized in that
the clamping sleeve (29) is configured as a slotted sleeve.

8. A receiver unit in accordance with claim 5,
characterized in that
the clamping sleeve (29) has an outer thread (30) and the receiver sleeve (25) has an inner thread (31) by means of which the clamping sleeve (29) can be connected to the receiver sleeve (25).

9. A receiver unit in accordance with claim 7,
characterized in that
the outer thread (32) and the inner thread (31) of the receiver sleeve (25) have different directions of rotation.

10. A processing head for an apparatus for a processing of material with a laser with a powder flow nozzle in accordance with claim 1 and a receiver unit.

11. A processing head in accordance with claim 10,
characterized in that
the powder flow nozzle (10) has a widening (17) and the receiver unit (39) has a clamping nut (34) having a push-out chamfer (38) which is configured and arranged in such a way that, on a displacement of the clamping nut (34) against a plug-in direction (14), the powder flow nozzle (10) is likewise displaced against the plug-in direction (14).
